(19) United States
(12) Patent Application Publication
(10) Pub. No.: US 2013/0179622 A1
(43) Pub. Date: Jul. 11, 2013

(54) SYSTEM AND METHOD FOR TRANSMITTING AND RECEIVING DATA USING AN INDUSTRIAL EXPANSION BUS

(71) Applicants: Gary L. Pratt, Hartland, WI (US); Todd Philip Pfister, Earlysville, VA (US)

(72) Inventors: Gary L. Pratt, Hartland, WI (US); Todd Philip Pfister, Earlysville, VA (US)

(21) Appl. No.: 13/345,583

(22) Filed: Jan. 6, 2012

(51) Int. Cl. G06F 13/36

(52) U.S. Cl. 710/314

(57) ABSTRACT

A system for transmitting and receiving data using an industrial expansion bus connected to a chassis is provided, the industrial expansion bus having a plurality of module slots, the system having a programmable logic controller (PLC) control rack and a PLC remote rack. The PLC control rack has a first embedded central processing unit (CPU), and a first peripheral component interconnect express (PCIe) module adapted to send and receive PCIe compliant signals. The PLC remote rack has a second PCIe module adapted to send and receive PCIe compliant signals, and a second embedded CPU. The first PCIe module and the second PCIe module are communicatively coupled with cable to provide an interface between the first and second CPUs. A method for polling a local peripheral and a distant peripheral is also provided.

### BACKGROUND OF THE INVENTION

1. Field of the Invention

The field of the invention relates generally to automation of electromechanical processes, and more particularly, to certain new and useful advances for expanding an industrial bus and polling distant peripherals.

2. Description of Related Art

A complex automated industrial system requires an organized hierarchy of controller systems to function. Generally, the hierarchy includes a Human Machine Interface (HMI) linked to programmable logic controllers (PLC) via a non-time-critical communications system (e.g. Ethernet). At the bottom of the control chain is a computer processing unit (CPU) which has a subsystem (i.e., a bus) that transfers data between components inside the CPU and links the PLCs to the components that perform certain tasks and gather data, such as sensors, actuators, electric motors, console lights, switches, valves and contactors.

Manufacturing plants, at times, need to expand operations. Typically, this requires an expansion of computer hardware, connections, sockets, memory, etc. In the preexisting hardware, there is only a certain number of available slots and a certain amount of available room. Once either the slots run out or there is not enough room, steps need to be taken to expand the systems. Rather than disposing of the old hardware, it is usually more cost effective to expand the computers bus though the use of an expansion bus, or in an industrial setting, an industrial expansion bus. An expansion bus is made up of electrical pathways and protocol which moves information between the internal hardware of a computer system (including the CPU and RAM) and the peripheral devices, allowing for the expansion of the PLC Control system. Further, many new systems require more I/O than can be fit in a single rack. These need to be expanded to remote racks through the use of an expansion bus.

The expansion bus includes a physical layer in the form of a module that acts as the physical layer of the expansion bus (also referred to as an expansion board, adapter module or accessory module), which is a module that can be inserted into an expansion slot of PLC expansion bus or backplane to add functionality to an industrial PLC Control system via the expansion bus.

In the past, PCI and serial-based hardware have been used in the industrial expansion bus. Conventional PCI is an integrated circuit fitted into a module slot for attaching hardware devices in a computer. These devices can take either the form of a module or port. The PCI Local Bus is common in modern computers. Typical PCI modules used in PCs include: network modules, sound modules, modems, extra ports such as USB or serial, TV tuner modules and disk controllers.

Other busses include RS-232 expansions with serial expansion and a serial communications only rack. More recently, however, PCI-Express (PCIe) has been used as a high speed dual-simplex, point to point serial differential low-voltage interconnect. For example, “Introduction to PCI Express—A New High Speed Serial Data Bus” by S. K. Dhawan, describes the use of PCIe as a high-speed dual-simplex, point-to-point serial differential low voltage interconnect. On the transmit side, parallel data is shifted out serially and on the receive side serial data is shifted in to registers for parallel data output. This bus can be used to connected to modules or boxes via twisted pair copper wires.

PCIe is also described in US Patent Application No. 20100115174A to Akyol which describes load balancing in a virtual computing environment comprising a plurality of PCI-Express switches coupled to a plurality of network interface devices (NICs).

However, there are many drawbacks with the above-described ad hoc approaches. For example, these systems are not applicable for use in with the preexisting modules and are not extendible beyond the I/O available in the local control rack, and impose a high amount of computer overhead thereby slowing down the systems. Further, such systems are complicated to use and upgrade.

Accordingly, to date, no suitable system or method for expanding an industrial expansion bus using low computer overhead exists.

### BRIEF SUMMARY OF THE INVENTION

The present disclosure describes embodiments for transmitting and receiving data using an industrial expansion bus. Embodiments of the invention provide a system for transmitting and receiving data using an industrial expansion bus connected to a chassis, and the industrial expansion bus having a plurality of module slots.

The system comprises a programmable logic controller (PLC) control rack comprising a first embedded central processing unit (CPU), and a first peripheral component interconnect express (PCIe) module adapted to send and receive PCIe compliant signals. The system also has a PLC remote rack comprising a second PCIe module adapted to send and receive PCIe compliant signals, and a second embedded CPU, wherein the first PCIe module and the second PCIe module are communicatively coupled with a fiber or copper cable to provide an interface between the first and second CPUs.

A method is also provided for polling a local peripheral and a distant peripheral, distance being defined as a function of sweep time, the method executable by a central processing unit, and comprising outputting a first simultaneous query to each of the peripherals, receiving the query at the local peripheral, sending a response to the query from the local peripheral, receiving the query at the distance peripheral; receiving a response from the local peripheral at the CPU, and outputting a second simultaneous query to each of the peripherals, wherein a first response from the distant peripheral and a second query are in transit simultaneously without interrupting the sweep time.

Benefits over and difference from prior approaches is that embodiments of the invention provide an expansion bus that is compatible with preexisting modules, the ability to use “off-the shelf” expansion chases (e.g., no need for custom designs), increases in latency, and ease of use.

### BRIEF DESCRIPTION OF THE DRAWINGS

Other features and advantages of the disclosure will become apparent by reference to the accompanying drawings, in which:

FIG. 1 is a schematic block diagram of an exemplary industrial control system in accordance with an embodiment of the present invention;

FIG. 2 is a schematic block diagram of an exemplary bus and PLC interconnect system in accordance with an embodiment of the present invention;

FIG. 3 is a schematic block diagram of an exemplary PLC control and PLC remote rack system in accordance with an embodiment of the present invention;

FIG. 4 is a schematic block diagram of an exemplary PLC control and PLC remote rack system and PCIe switch in accordance with an embodiment of the present invention;

FIG. 5a is a schematic block diagram of a bus backplane in accordance with an embodiment of the present invention;

FIG. 5b is a schematic block diagram of a bus backplane together with a PLC remote rack in accordance with an embodiment of the present invention;

FIG. 6 is a schematic block diagram of a bus backplane together with PLC remote racks and a PCIe switch in accordance with an embodiment of the present invention;

FIG. 7 is a schematic block diagram of a bus backplane together with PLC remote racks and embedded PCIe in accordance with an embodiment of the present invention;

FIG. 8 is a schematic block diagram of a daisy chain configuration in accordance with an embodiment of the present invention;

FIG. 9 is a schematic block diagram of the PCI/PCIe expansion chassis in accordance with an embodiment of the present invention;

FIG. 10a is a schematic block diagram of an exemplary PLC control and PLC control rack system and with a shared memory in accordance with an embodiment of the present invention;

FIG. 10b is a schematic block diagram of an exemplary PLC control and PLC control rack system and with an embedded shared memory in accordance with an embodiment of the present invention;

FIGS. 11a-f are functional block diagrams of a system for polling multiple peripherals at varying distances; and

FIG. 12 is a flow chart representing a step-by-step method in accordance with an embodiment of the present invention.

Like reference characters designate identical or corresponding components and units throughout the several views, which are not to scale unless otherwise indicated.

### DETAILED DESCRIPTION

Embodiments of the present invention describe a method of using a PCIe bus as the physical layer of an Industrial Expansion Bus. Optional embodiments describe a system using a PCIe as a local backplane, a mixed-bus backplane to support traditional PCI and serial-based hardware, how the PCIe industrial expansion bus can be used in various topologies including switched star, and daisy-chain.

Embodiments of the present invention also describe a method of using transactional polling of peripherals to maximize the bandwidth utilization by allowing multiple peripheral queries to be in transit at the same time. This method can also be used to allow multiple queries to a single distant peripheral such that the transactions span multiple scan periods with the potential for multiple transactions to be in transit at any one time. Lastly, embodiments of the present invention describe a method for dealing with response latencies of greater than the sweep sample time.

As used herein, the term “peripheral(s)” may refer to sensors or actuators (e.g., electric motors, pneumatic or hydraulic cylinders, magnetic relays, solenoids, etc.), console lights, switches, valves contactors and the like connected into a control loop. The present invention is applicable in an analog control loop, and also a digital control loop. A sweep sample time is defined as the interval in which the CPU executes a scan on the peripherals. For example, during a sweep time, the CPU can receive data from input logic, run the data, and output the data to an output module.

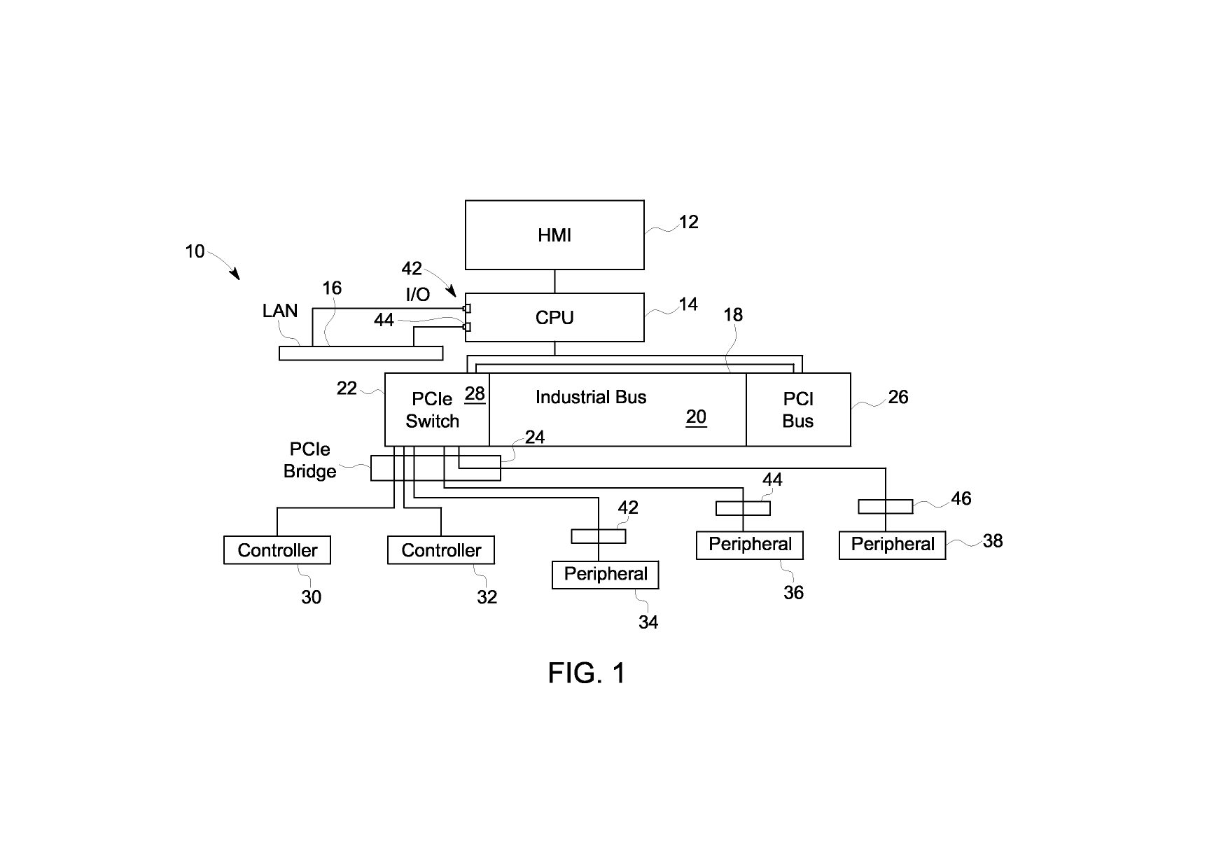

The industrial control system comprises a central processing unit (CPU) comprising a chassis that houses a processor and an industrial bus. The CPU is in communication with the analog input/output interface. The central processing unit has a processor configured to execute programmable instructions, which when executed by the processor causes the processor to send and receive commands to and from peripherals, each of which will be discussed in greater detail below with reference to FIGS. 1-12.

Specific configurations and arrangements of the claimed invention, discussed below with reference to the accompanying drawings, are for illustrative purposes only. Other configurations and arrangements that are within the purview of a skilled artisan can be made, used, or sold without departing from the spirit and scope of the appended claims. For example, while some embodiments of the invention are herein described with reference to industrial plants, a skilled artisan will recognize that embodiments of the invention can be implemented at theme parks and the like.

As used herein, an element or function recited in the singular and proceeded with the word “a” or “an” should be understood as not excluding plural said elements or functions, unless such exclusion is explicitly recited. Furthermore, references to “one embodiment” of the claimed invention should not be interpreted as excluding the existence of additional embodiments that also incorporate the recited features.

With reference now to FIG. 1, a block diagram of an exemplary system 10 having a human machine interface (HMI) 12 coupled to a CPU 14 is shown. The CPU 14 is coupled to a local area network (LAN) 16 supported by Ethernet and connected to the CPU 14 through inputs and outputs 42 and 44. The functional subsystems are housed in chassis 18 which includes an industrial bus 20. The chassis 18 contains modules for data acquisition, real-time control, sensors, and smart I/O devices. The chassis 18 may further comprise a backplane with slots for installing modules, a power supply, cooling fans, and connectors. The chassis 18 may be either active or passive in various embodiments of the present invention. Typically, an active backplane comprises active components on the backplane PCB (such as drivers, CPUs, bridges, etc.), and a passive backplane only comprises traces. Embodiments of the present invention are applicable to both active and passive backplanes.

The chassis 18, if preexisting, may comprise multiple slots to support either passive or active backplanes of different bus types. For example, a preexisting backplane may comprise an ISA bus having 16-bit data transfers at a clock speed of 8 MHz, or extended ISA having 32-bit data transfers may be used. More typically, a PCI may be used to transfer 32 or 64 bits of data at a clock speed of 33 MHz. In an optional embodiment, the compact PCI (cPCI) in a Versa Module Euromodule (VME) bus may be applicable with the present invention, including but not limited to, VME64, VME320, and VME160.

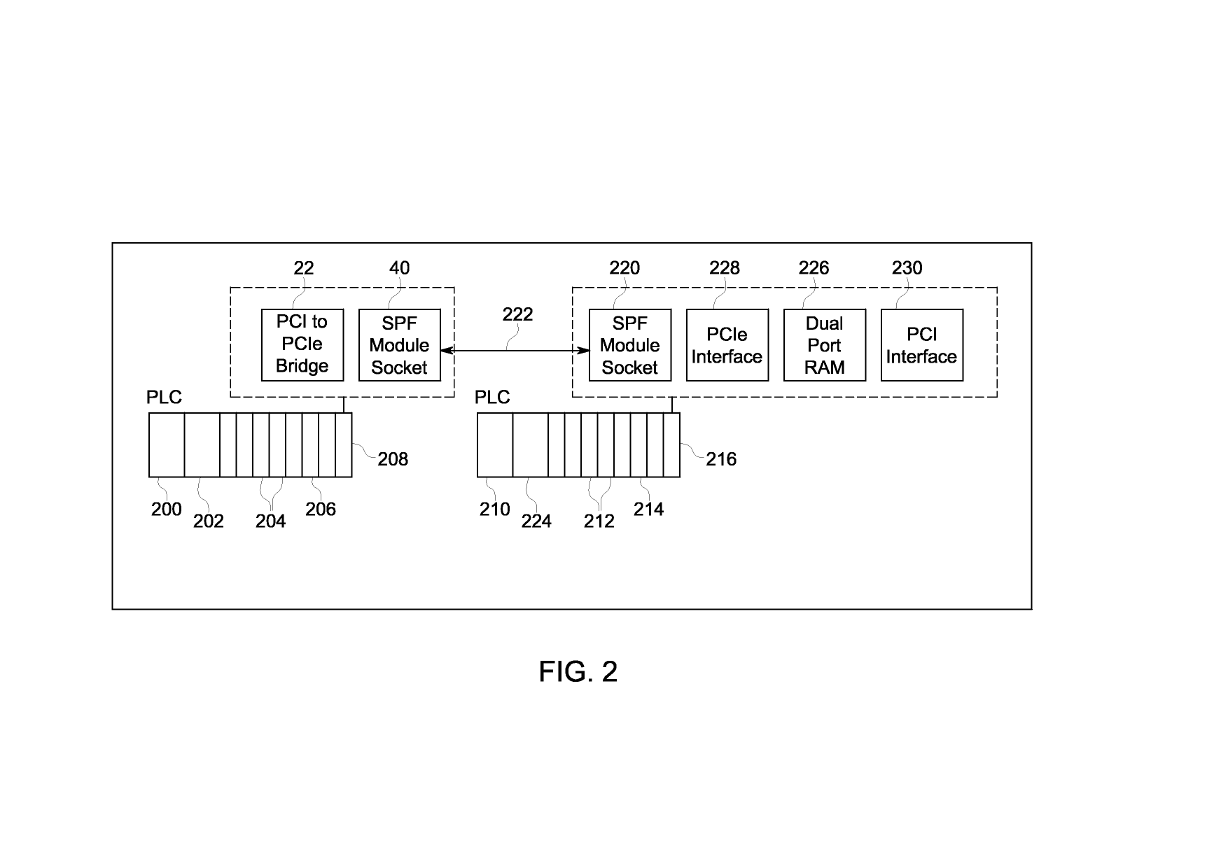

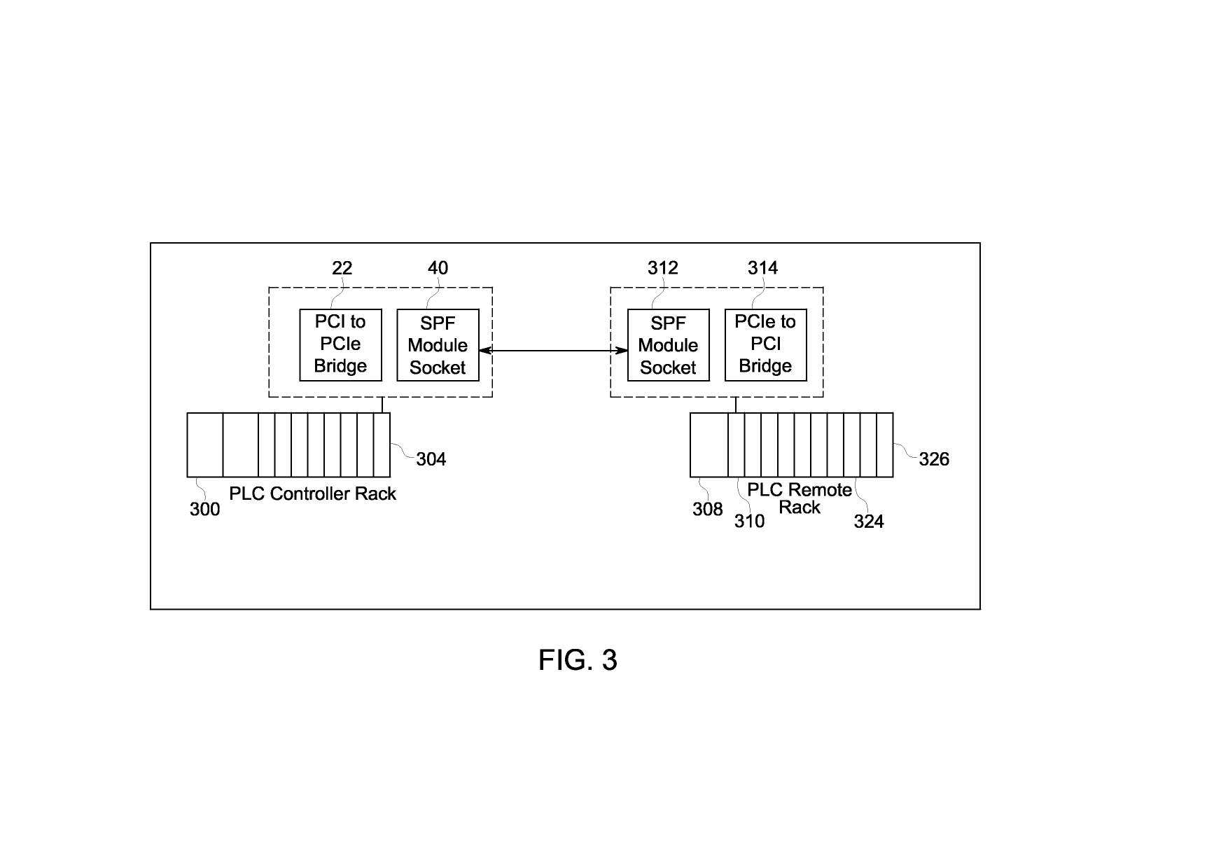

The components of the chassis 18, as used herein, may be collectively referred to as the PLC control rack, shown in greater detail in FIGS. 2-10. In optional embodiments, the backplane comprises multiple PCIe slots (shown in FIGS. 2-10), at least one of which is electronically coupled to a PCIe switch 22. The PCIe switch 22 is configured to create multiple endpoints from a single endpoint. As such, multiple peripherals 34-38 may be connected to a single endpoint. The PCIe switch 22 provides point-to-point serial interconnects. The PCIe switch 22 is connected through a first PCI to PCIe bridge 24 which is electrically and communicatively coupled to remote peripherals 34-38 or controllers 30 and 32. The first PCIe to PCIe bridge 24 is configured as a first interface between the CPU 14 and the peripherals and is configured to convert, for example, thirty-two parallel streams into one serial stream for transmission to the peripherals 34-38. Each peripheral 34-38 may be connected to its own PCI to PCIe bridge (a second, third and fourth PCI to PCIe bridge 42-46) which is configured to convert the serial stream back to the appropriate number of parallel streams. The bridges 24 and 42-46 may comprise a dual write buffer on each bus interface to post memory write, and to allow the original bus to post a first and second write request to the bridge while the first write request is being processed.

Referring still to FIG. 1, each peripheral 34-38 or controller 30, 32 may be connected to an integrated physical layer (PHYs) (shown in FIG. 2). The PHY may be configured to connect a link layer device to a physical medium such as an optical fiber or copper cable, to be discussed later with reference to FIGS. 2-10. The peripherals 34-38 may be remote PLCs, which may act to manage sequential relay control, motion control, process control, distributed control systems, and networking.

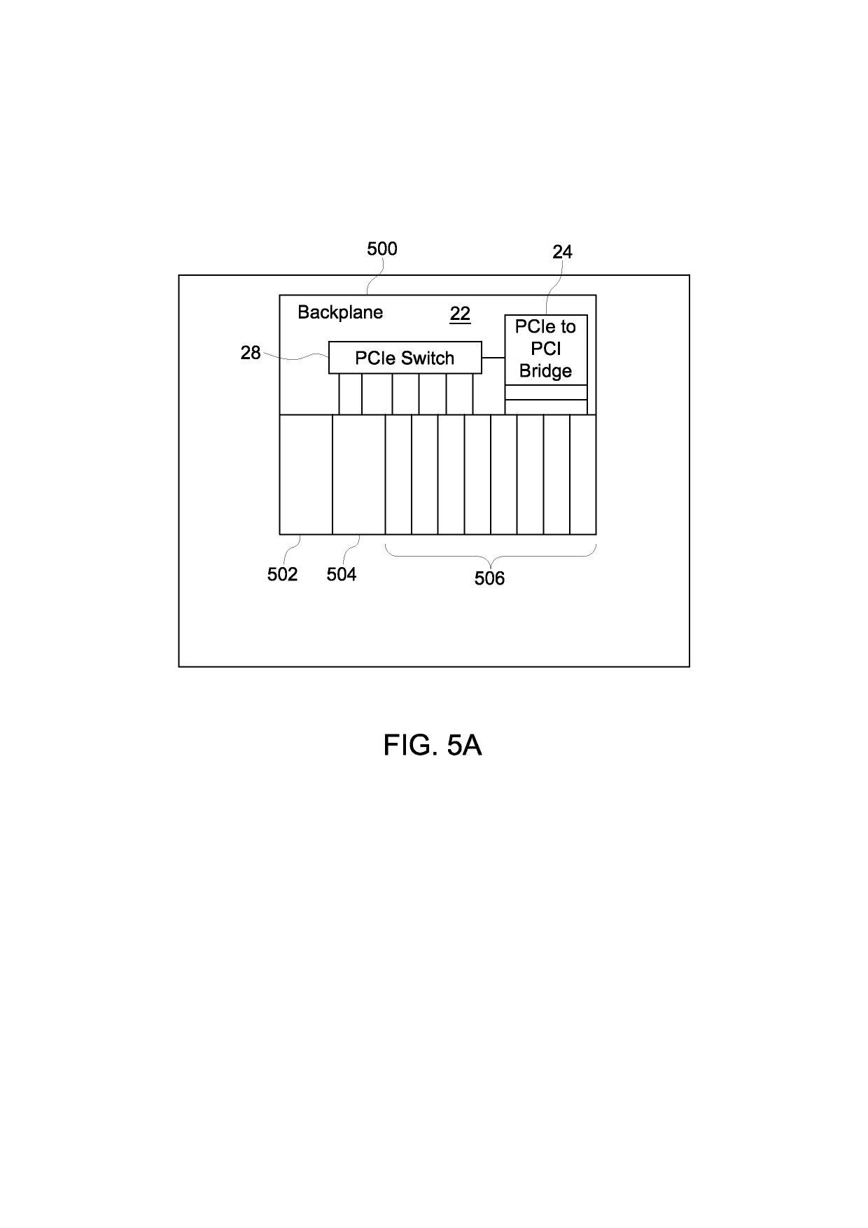

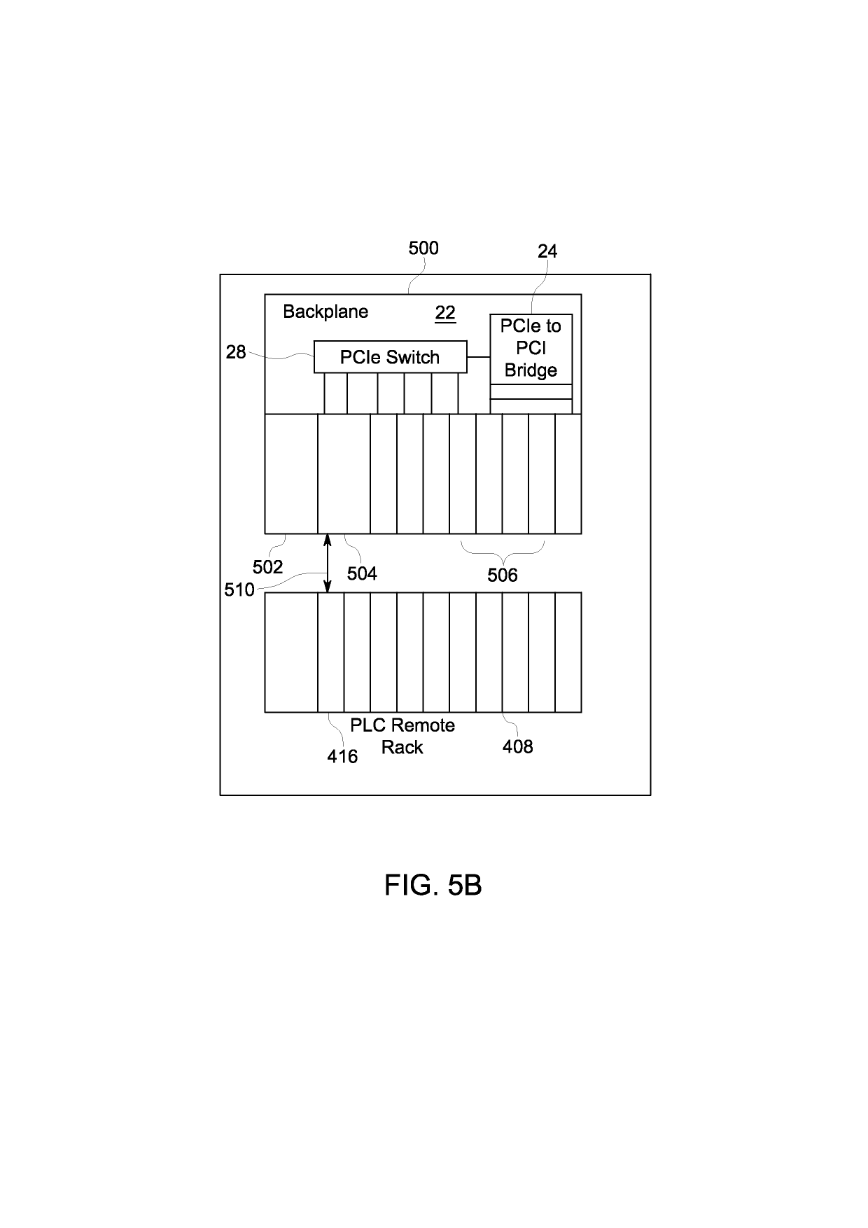

FIG. 2 shows two PLCs 200 and 210 connected together via the PCIe expansion bus 28. In this embodiment, the PLC control rack 200 is in communication with a PLC remote rack 210. This is particularly applicable when the chassis 18 houses conventional PCI as part of a PCI Local Bus standard. In this exemplary configuration, a first PCI to PCIe bridge 22 and a small form-factor pluggable (SFP) 40, which comprises a physical layer (PHY), are utilized to expand the local backplane (discussed further with reference FIG. 5) to form an expansion bus 28. The first bridge 22 and the first SFP 40 are configured to transition the PCIe PHY back to conventional PCI to access the PCI devices.

In this embodiment, the PCIe expansion bus provides a CPU 202 to CPU 224 interface. The PCIe module 208 in the PLC 200 is transparent to the PLC CPU 202 causing the PCIe 216 in the PLC 210 to appear as a local peripheral (in this case, the peripheral is a block of expansion random access memory (RAM) 226). The PCIe 216 in the PLC 210 acts as a local peripheral to the CPU 214 in the PLC 210. Both CPUs 208 and 216 will manage the other peripherals in their respective racks, and the CPU 214 in the PLC 210 is configured to read or write key parameters to the dual port RAM in the PCIe 216. The CPU 202 in the PLC 200 will then read and write the parameters from the RAM in PCIe 216 (via PCIe 208) and incorporate those parameters into its normal control function. This configuration has the primary advantage that it can utilize non-PCI modules which may be installed in the PLC 210. It has the additional advantage of being able to perform local control functions (which use only local I/O) autonomously from the PLC 200, and only share certain parameters with the controller rack thus reducing the load on the PLC 200 CPU 202. For example, PLC 210 may be installed near the periphery of a manufacturing site and control the flow in a nearby valve. The PLC 210 may take in numerous inputs (such as pressures and temperatures), calculate a flow rate and output a value to a valve command to maintain a desired flow. Further, if the PLC 200 provides the remote rack 210 with the desired flow, and the PLC 200 requires the actual flow and the material temperature to be able to perform other control and monitoring functions. In this example, the PLC 210 CPU 214 may periodically query its inputs, calculate the flow, read the RAM to get the desired flow, calculate the valve adjustment required and output the appropriate value to the valve command. The CPU 214 may also write the calculated flow and the temperature to the RAM. The CPU 202 would query its inputs, read the RAM for the temperature and actual flow, run through its calculations, and output its outputs to its local peripherals and write the desired flow to the RAM 226.

Physically, these transactions flow as follows: The CPU 214 initiates transactions to its peripherals on its local busses (e.g., PCI or backplane RS232). One of these transactions is a PCI 230 reads the dual port RAM in 216. The CPU 202 reads and writes this same RAM by initiating its own PCI transactions, which are converted to PCIe in 22, further converted to fiber or copper in 40, transferred over a copper or fiber interconnect 222 to PCIe 216 which then provides access to the dual port RAM.

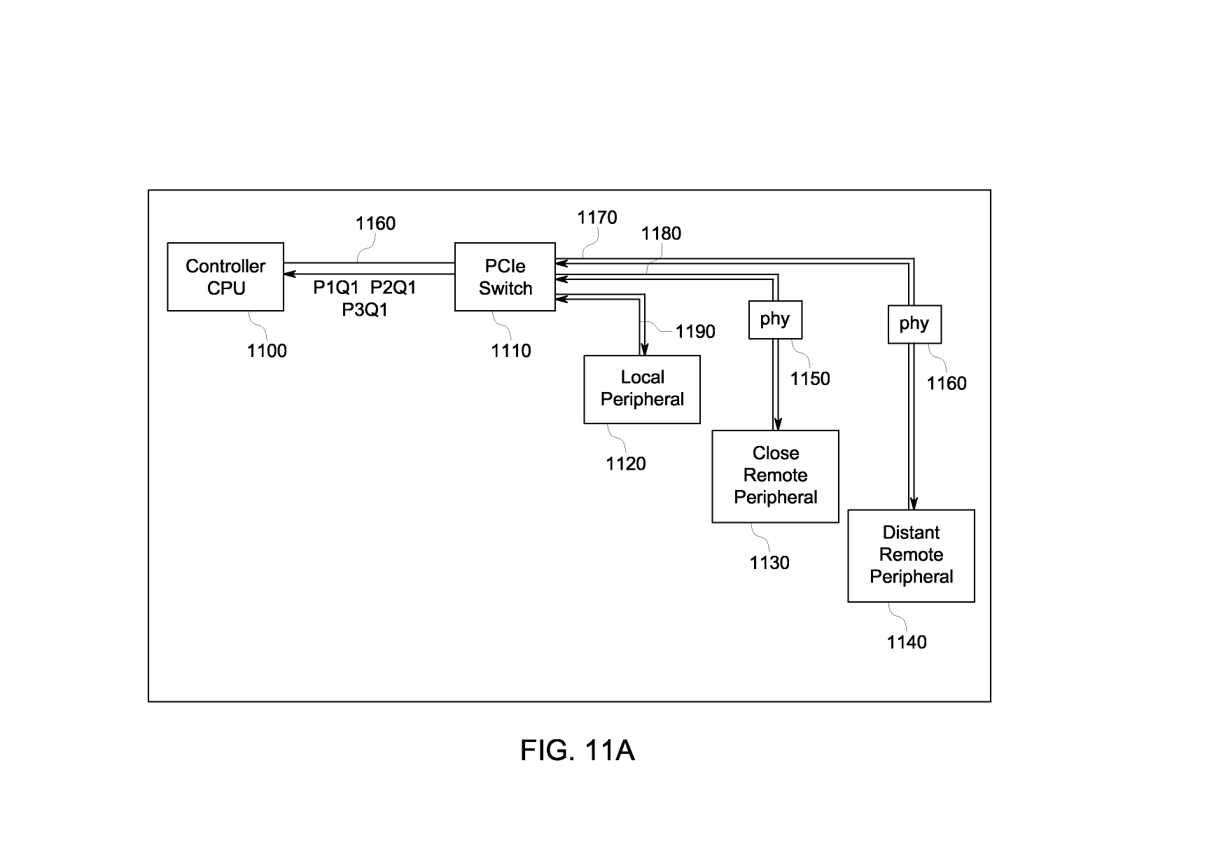

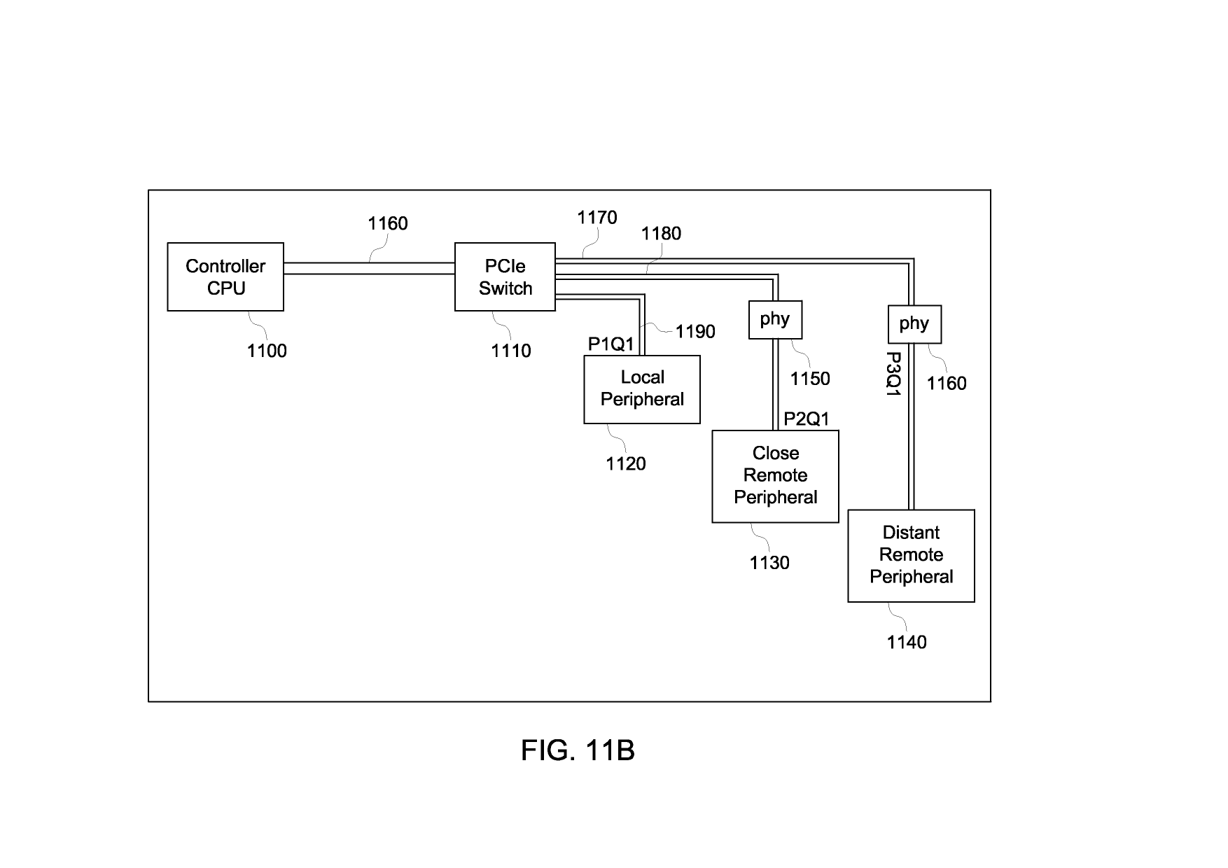

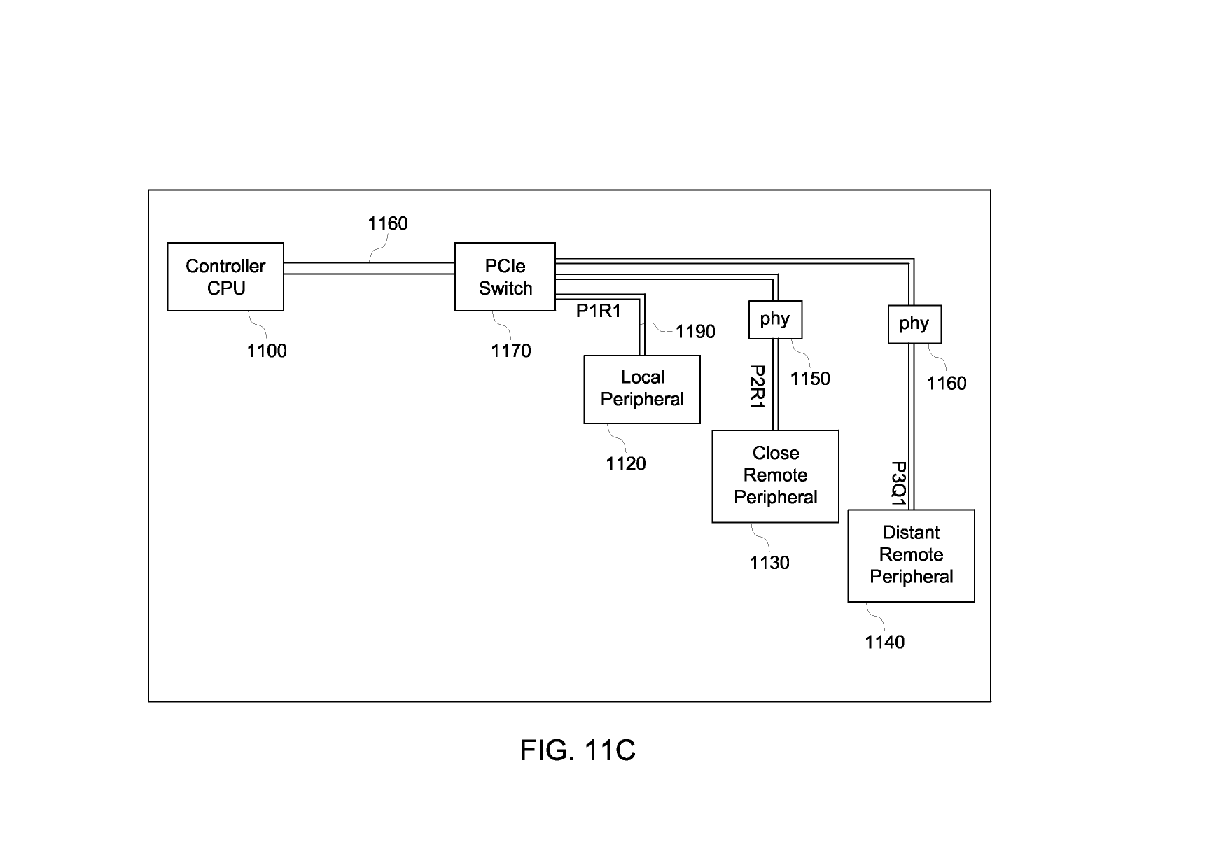

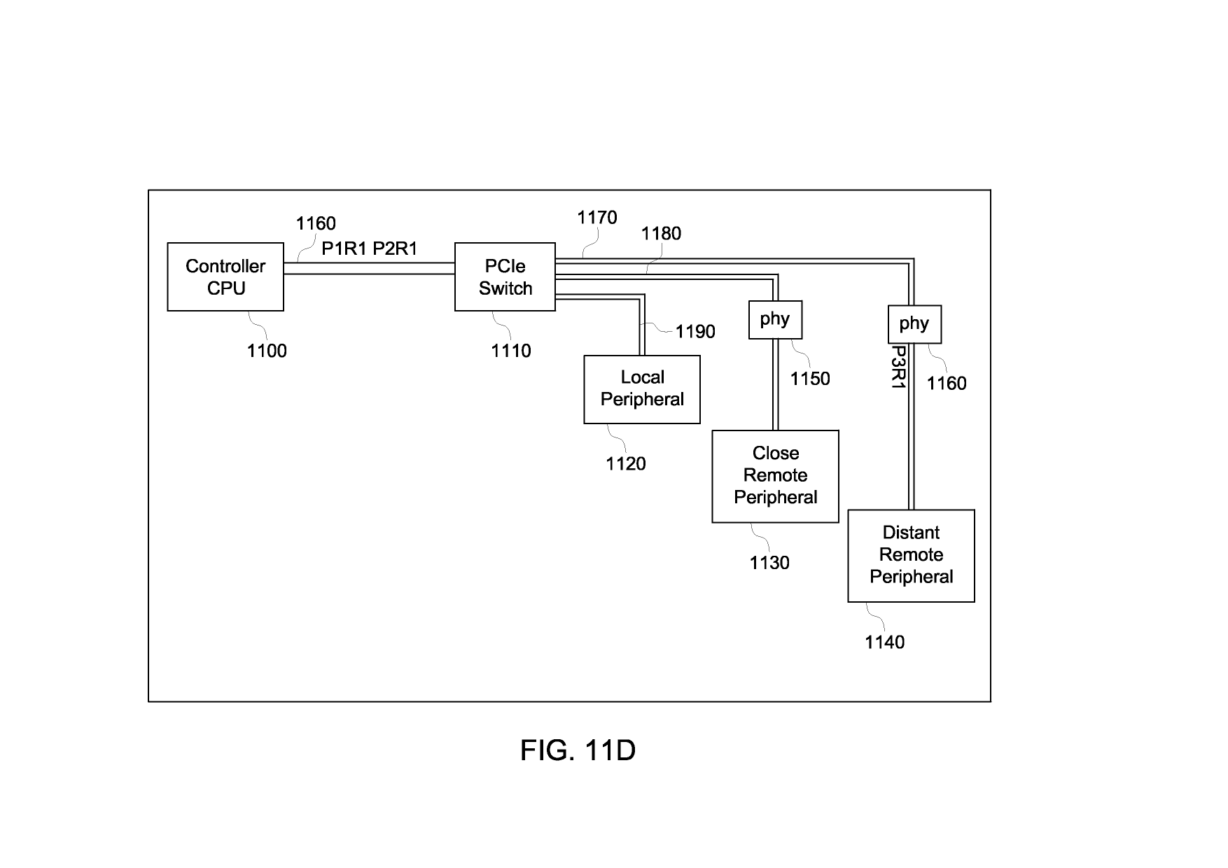

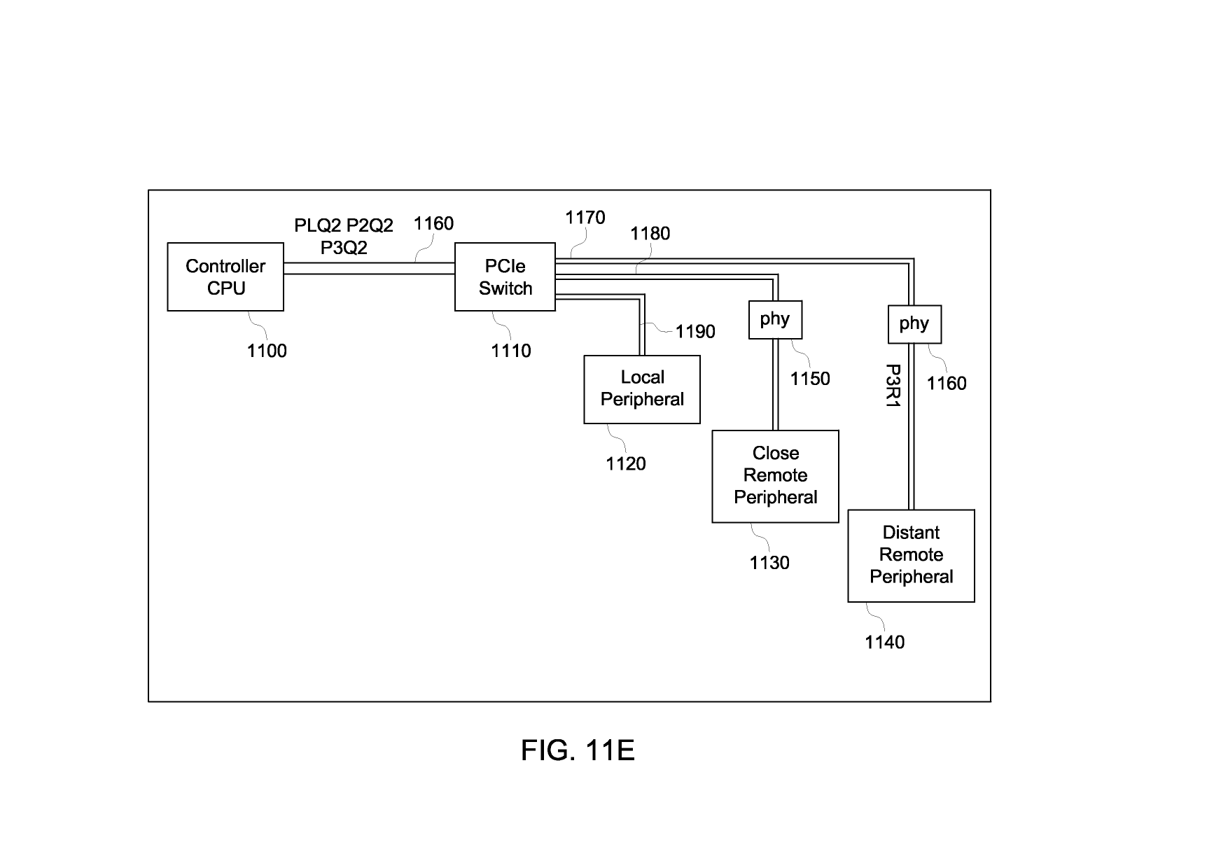

In this way, CPU 14 (see FIG. 1) the remote PLC can quickly and efficiently manage a control distant control loop. This, in turn, increases the speed of communicators, efficacy, and latency, particularly when the remote rack is at an extremely distant point. The remote rack 210 may be sufficiently far from the controller rack 200 such that a complete communication transaction cannot take place within a single scan of the controller CPU 202. This situation is addressed in FIGS. 11a-l. It should be noted that in optional embodiments of the present invention, the PLC may have external I/O modules attached to a computer network that plugs into the PLC.

In another exemplary embodiment, FIG. 3 shows a PLC control rack 300 comprising a CPU 302 and a PCIe 304. The PLC control rack 300 comprises a CPU 302, multiple input/output (I/O) channels 306 and a PCIe 304 having in I/O. A PLC remote rack 308 is also provided having a PCIe 310 configured for PCIe communications. In this embodiment, The PCIe 304 of the control rack 304 is coupled to the PCIe 310 of the PLC remote rack by a copper or fiber cable 322 through PCI to PICe bridge and SPF module socket 40 (which comprises a PHY). The SPF module socket 40 is coupled to a second SPF module socket 312 via copper or fiber cable which resides on the PCL remote rack. A second PCIe to PCI bridge 314 is coupled to the PCIe 310 and the SPF module socket 312, and is configured. The PCIe 216 is coupled directly to a second PCI to PCIe bridge 218 and the second SPF module 220 and is configured to convert a received serial stream into several parallel channels.

However, in this embodiment, the remote PLC does not have an embedded CPU. As such, the CPU 302 of the control rack 304 deems all modules 324 and 326 in the remote rack as being in the local control rack, and provides complete transparency and complete control of the remote rack 308. As such, no control software is needed in the remote rack 308, and the second CPU is not necessary. Also, in this embodiment, the remote rack requires no programming or program maintenance.

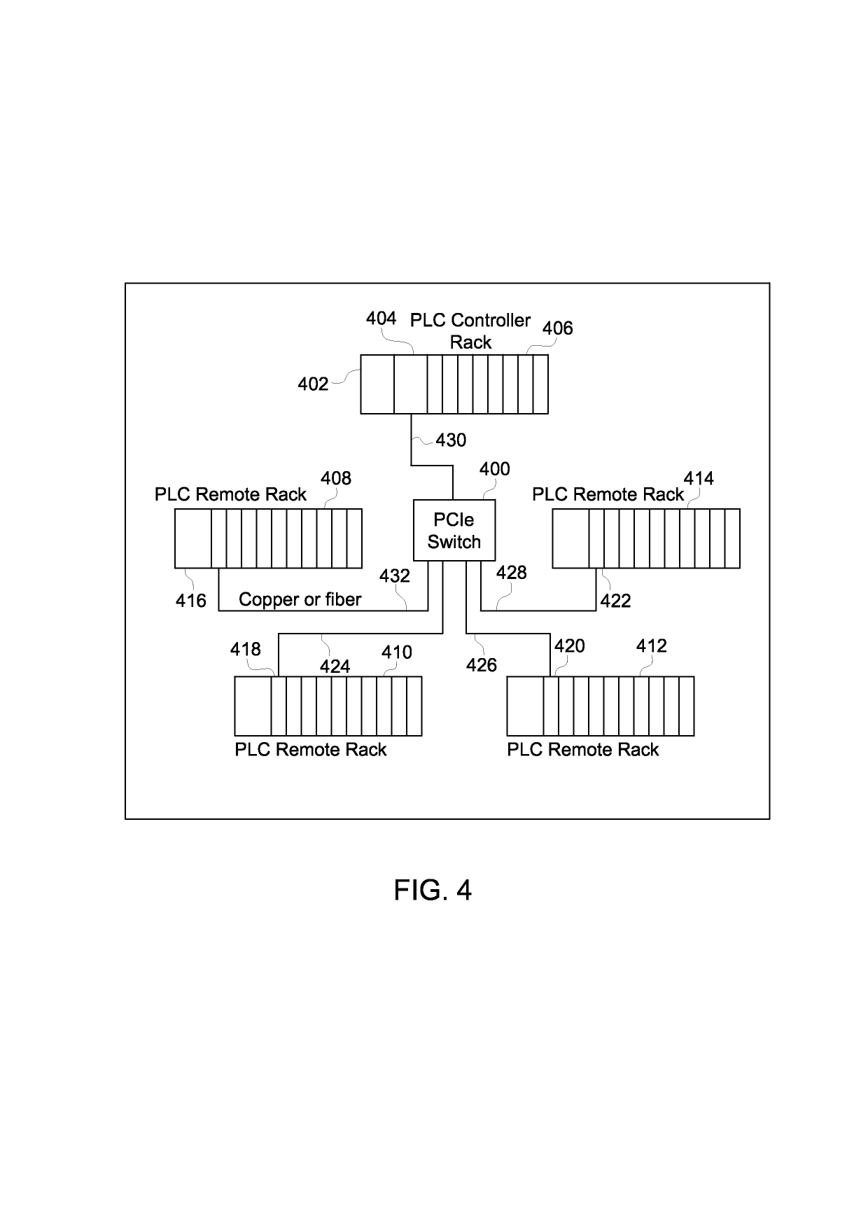

Referring now to FIG. 4, in an exemplary embodiment of the present invention, the PCIe Industrial Expansion Bus is further expanded in a star configuration using an external PCIe switch 400. The PCIe switch 400 is analogous to the switch 22 of FIG. 1, and is configured to create multiple endpoints from a single endpoint. As such, multiple peripherals may be connected to a single endpoint. As shown in FIG. 4, the PCIe switch 400 is coupled to a PLC control rack 402 at the CPU 404. The PLC control rack 404 also comprises a PCIe 406, but in this embodiment, the electrical coupling is to the CPU 404. Four PLC remote racks 408, 410, 412, and 414 each having respective PCIe's 416, 418, 420, 422. Each of the remote racks 408-414 are coupled to the PCIe switch 400 via the PCIe's 416-422 of each of the remote racks. Each of the connections are made with copper or fiber cables 424-432. This configuration provides expansion to multiple remote racks using a low-cost off-the-shelf PCIe switch.

Referring now to FIG. 5a, a backplane 500 which comprises a power source 502, a CPU with an SPF connection 504 and multiple PCIe slots 506, each slot electronically coupled to a PCIe switch 22, and through the PCIe switch 22, the PCIe to PCI bridge 24. In this exemplary embodiment, the PCIe Industrial Expansion Bus 22 is utilized as a local backplane bus 500. As such, bus-based devices such as convention PCI can be accommodated along with the PCIe based devices in the same backplane 500. Optionally, an add-on adapter which comprises a PCI to PCIe bridge configured to adapt preexisting modules to the PCIe bus may be used. For example, the adapter could be realized as a thin interposer of the same height and width of the current PCI module. While PCIe modules are generally deeper (i.e., have a greater volume) than older modules by approximately the depth of the interposer module, both modules are identical size when the older module has the interposer attached. As such, the interposer may also contain a microcontroller to accommodate older serial-based modules. Most current microprocessors provide several native PCIe channels. One PCIe channel provides roughly twice the bandwidth of an extended length PCI bus, so one or two channels dedicated to the local bus would be adequate to provide the same performance as current technology.

Referring now to FIG. 5b, the backplane of FIG. 5a and a PLC remote rack of FIG. 4 is shown connected by a copper or fiber cable 510. The copper or fiber cable 510 is connected to the CPU with SPF connections 504 on the backplane 500 and to the PCIe 416 on the remote rack 408. In this way, additional unused PCIe channels on the CPU 504 could be utilized to provide direct support for expansion directly from the CPU module.

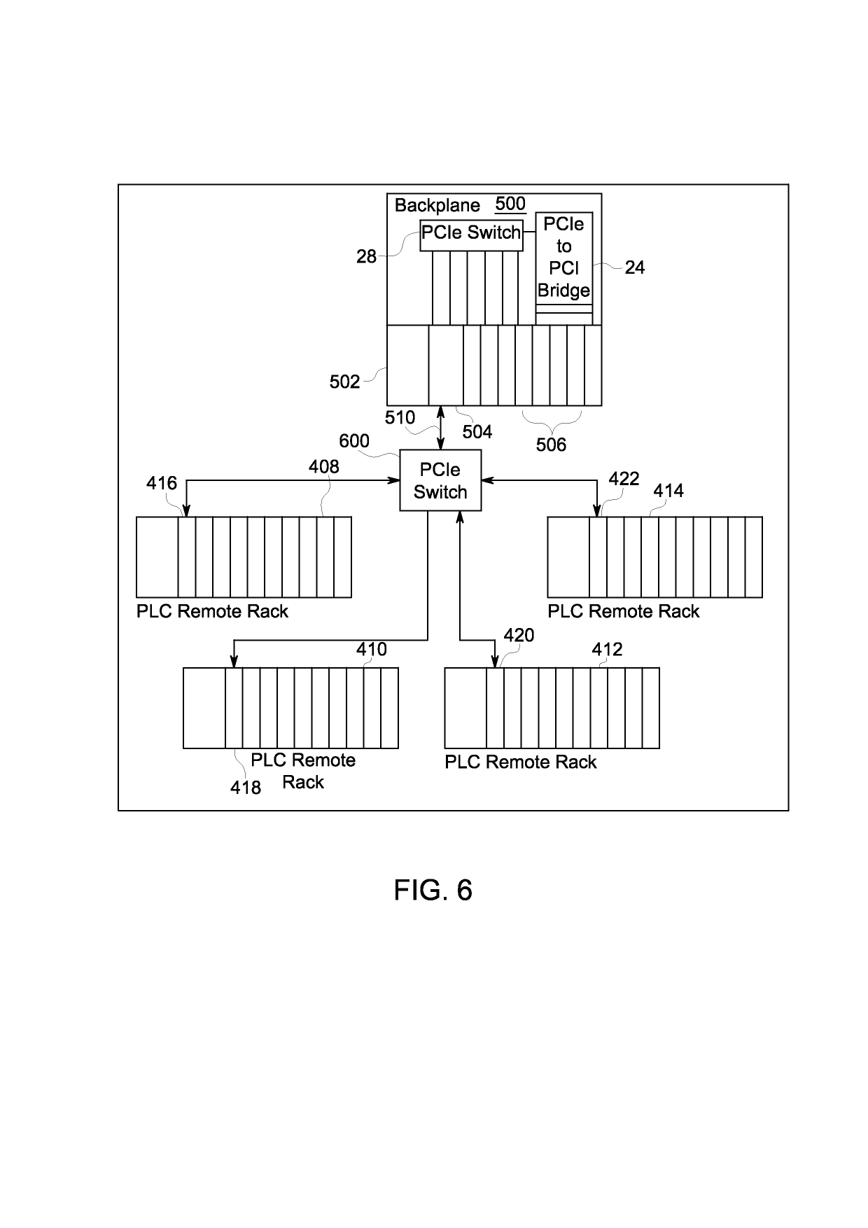

Referring now to FIG. 6, the backplane of FIGS. 5a and 5b are shown connected to a PCIe switch 400. The backplane 500 which comprises a power source 502, a CPU with an SPF connection 504 and multiple PCIe slots 506, each slot electronically coupled to a PCIe switch 22, and through the PCIe switch 22, the PCIe to PCI bridge 24. The CPU 504 supported PCIe expansion is expanded by use of an external PCIe switch 600. The PCIe switch is connected to each of the remote PLC racks 408 to 414 which have respective PCIe's 416, 418, 420, 422. Each of the remote racks 408-414 are coupled to the PCIe switch 600 via the PCIe's 416-422 of each of the remote racks. Each of the connections are made with copper or fiber cables 422-430. This configuration provides access to multiple remote racks without the need for a PCIe module in the controller rack.

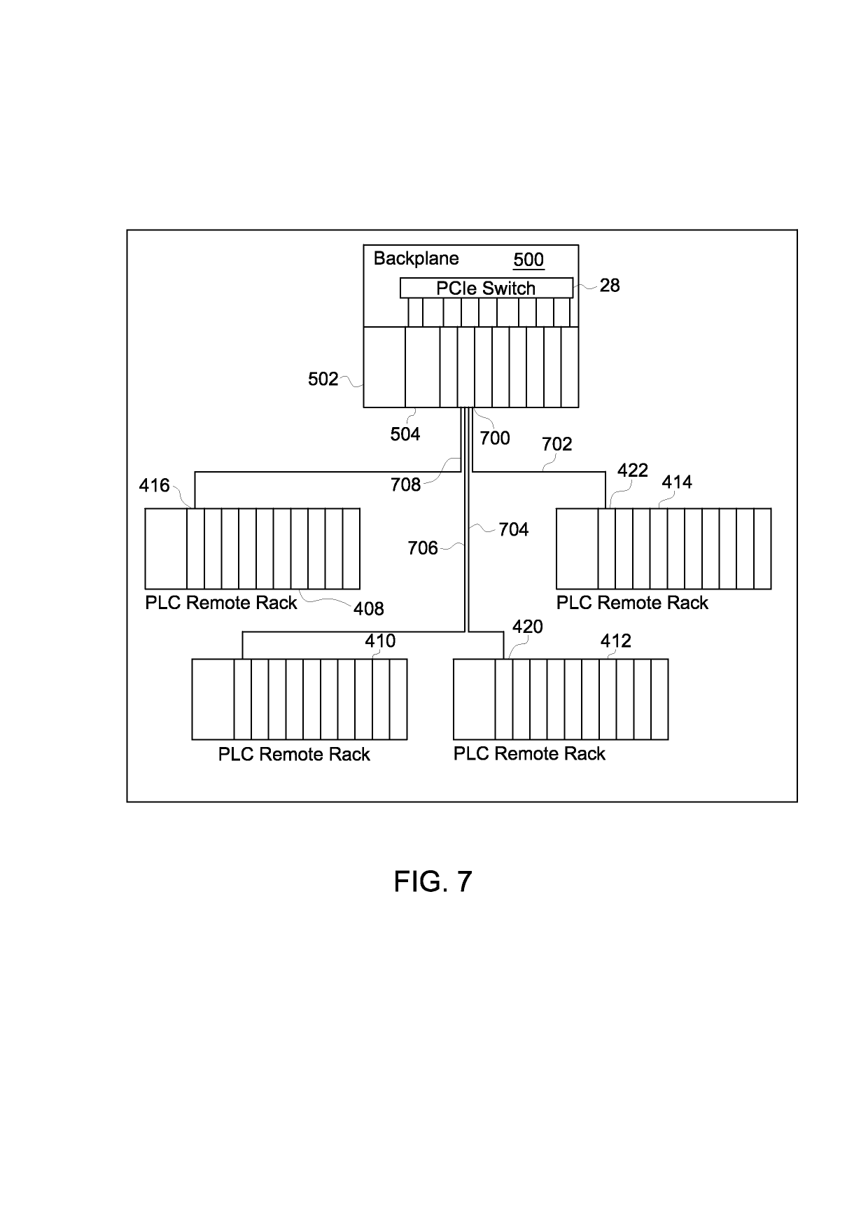

In an optional embodiment of the present invention, shown in FIG. 7, a PCIe switch 700 could be incorporated directly into a module to provide the same expansion capability without the use of an external PCIe switch 600. In this embodiment the PCIe switch 700 has a plurality of channels that directly connect to copper or fiber cables 702, 704, 706, 708 which, in turn, connect to the PCIes of each of the remote PLCs, respectively. In this exemplary embodiment, a quad PCIe switch is used and connected directly to four peripherals, but it should be noted that many more peripherals may be connected through the switch 700, or multiple switches may be employed in preexisting module slots.

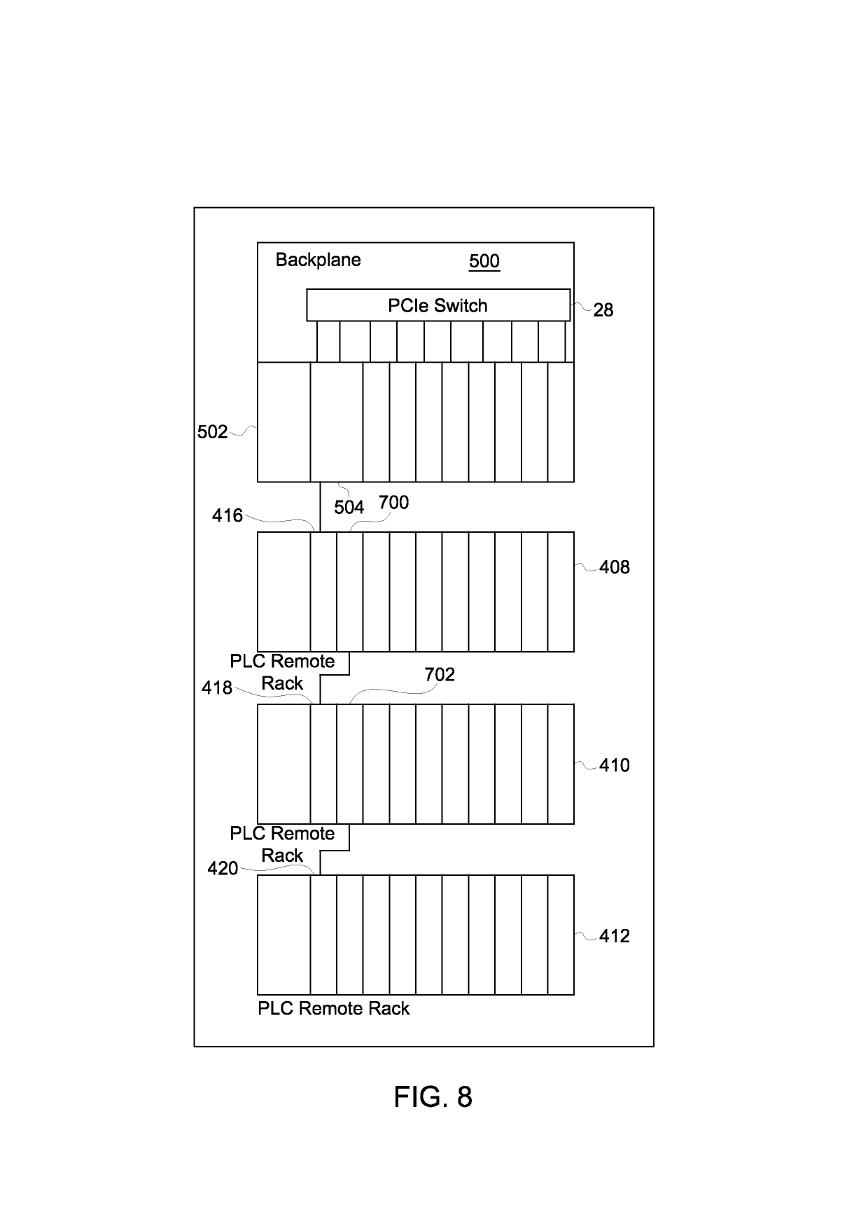

FIG. 8 shows another exemplary embodiment in which the Industrial PCIe Expansion Bus 22 is daisy-chained from PLC remote rack to other PLC remote racks. In this exemplary embodiment, while a linear topology is shown, it should be noted that a ring topology (e.g., daisy chain loop) may be utilized as well. In this embodiment, the CPU of the backplane 500 is connected to the PLC remote rack at the PCIe 416. However, in this embodiment, a second PCIe 700 is employed which is in communication with first PCIe 416, but also connected to the second PLC remote rack 410 at the PCIe 418. Again, like the first remote PLC 408, the second remote PLC 410 has a second PCIe 702 which is connected to a third remote rack 412, all via a copper or fiber cable. This approach can connect many more distant peripherals as well without the need for an internal or external switch. Also, it should be noted that this daisy chain approach could be combined with the quad-module of FIG. 7 to provide a hybrid approach of chains and stars.

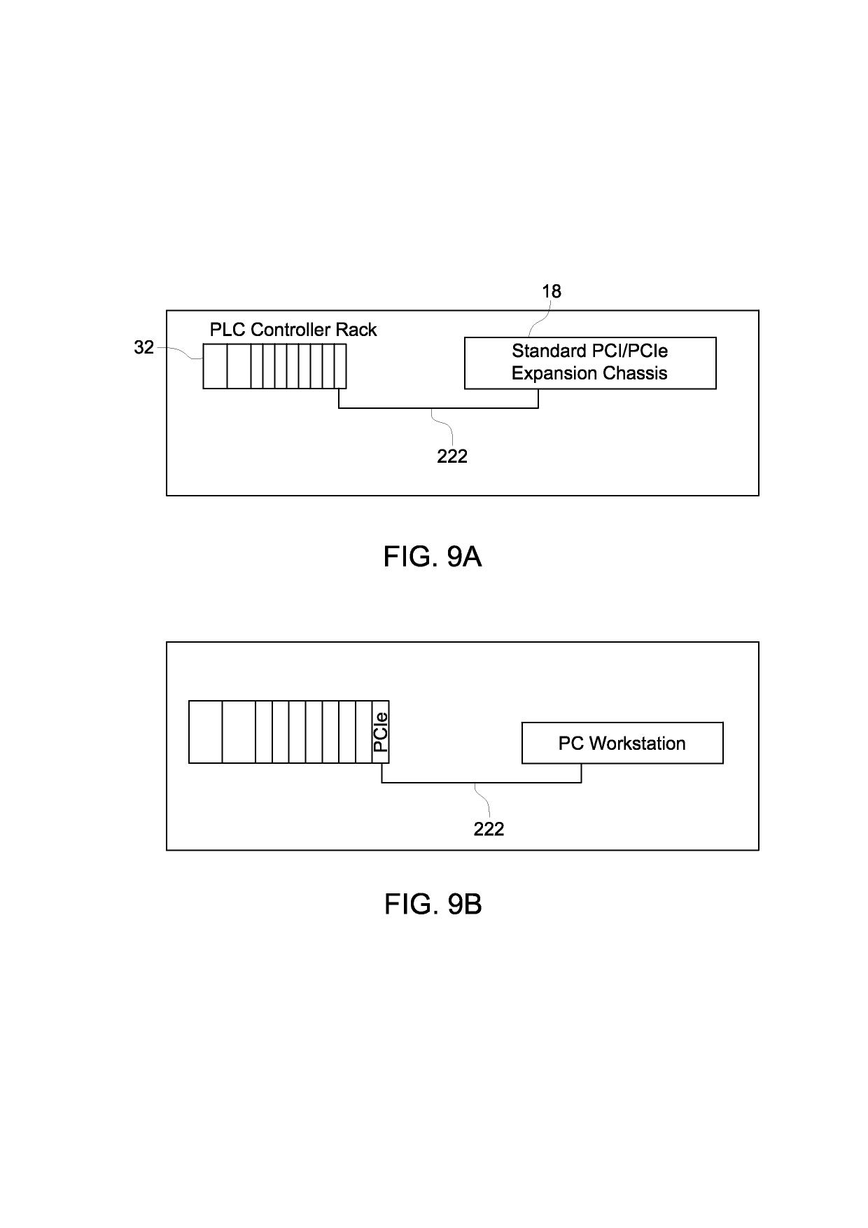

FIG. 9a shows the connection of the PLC control rack 32 to the PCI/PCIe expansion chassis 18. This allows a PLC to utilize any of the large volume of standard off-the-shelf PCI or PCIe boards available in the market as modules. In FIG. 9b, the standard PCIe/PCI expansion chassis 18 is replaced with PC Workstation 902. This embodiment provides high-speed deterministic communication from a PLC 32 to a PC when Ethernet or other standard interfaces would not have the necessary capacity, speed, or synchronization.

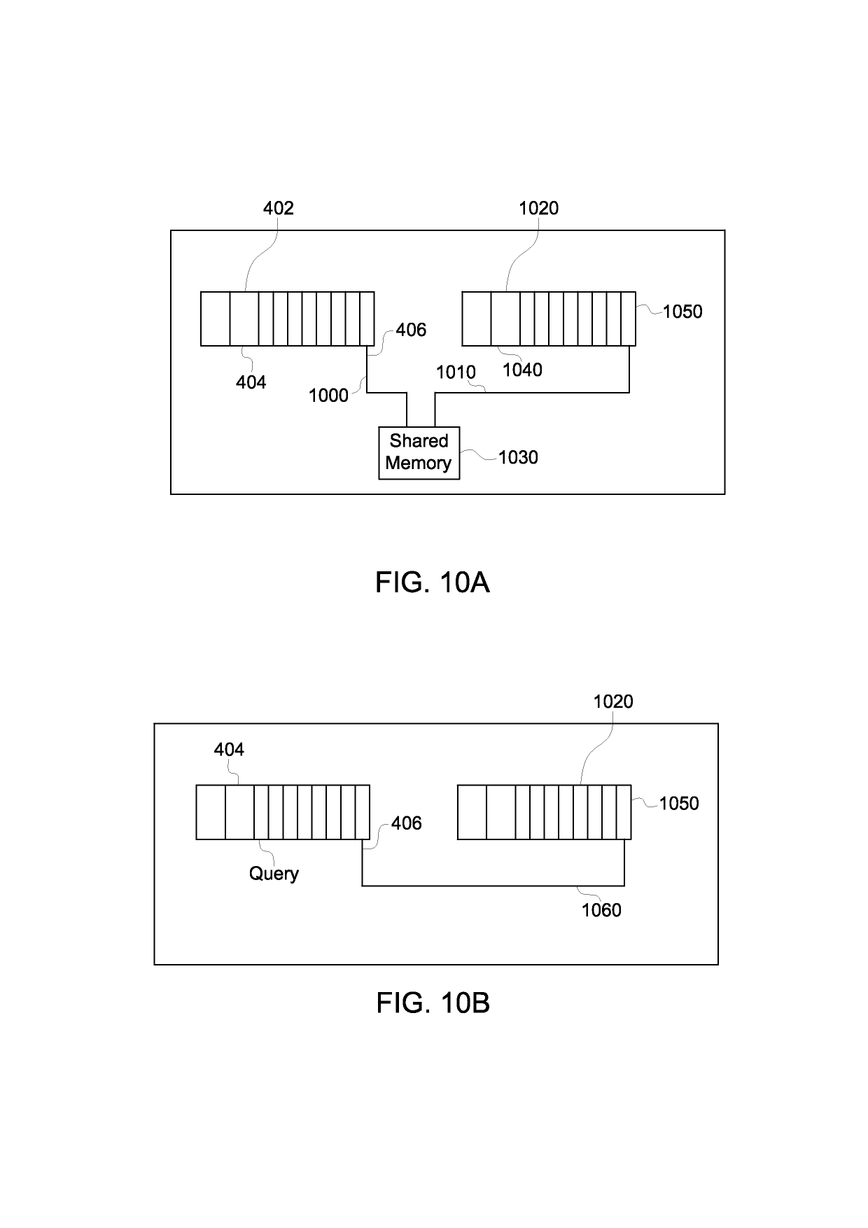

Referring now to FIGS. 10a and 10b, optional embodiments of the present invention are shown in which implementation of data sharing and failover for redundant controllers is used. For example, in FIG. 10a the PLC control rack 402 comprises a CPU 404 and a PCIe 406. The PCIe 406 is connected, thorough a copper or fiber cable 1000 to a shared memory 1030. The shared memory is further connected to a second PLC control rack 1020 having a second CPU 1040 and a second PCIe 1040. The second PCIe is connected to the shared memory through copper or fiber cable 1010. FIG. 10b shows show each of the control rack 402 may have an imbedded shared memory in the PCIe module connected to the second control rack 1020. More specifically, the PCIe 406 is connected to the PCIe 1050 via copper or fiber cable 1060. These configurations can be expanded to any number of controllers for triple or greater redundancy.

Referring now to FIGS. 11a-11l, a functional block diagram of polling transactions is shown. In this embodiment, the polling transactions can be executed such that multiple transactions can be in transit at the same time without decreasing latency of the CPU. As used herein, the terms “distant” and “close” are a function of the sampling period which is the time allotted in the scan for input and output scans, and the propagation delay of the communications media and interface electronics, and the time for the peripheral device to carry out its action and respond. In this exemplary embodiment, the controller CPU 1100 is connected to the PCIe switch 1110, which is further connected to a local peripheral 1120, close remote peripheral 1130 and distant remote peripheral 1140. The local peripheral 1120 is connected without an intermediary (i.e., directly connected) to the PCIe switch 1100, while the close remote switch is connected to the PCIe switch through a PHY 1150, and distant remote peripheral 1140 is connected to the PCIe switch though PHY 1160. P1Q1, P2Q1, and P3Q1 represent peripheral queries whilst P1R1, P2R1 and P3R1 represent peripheral responses.

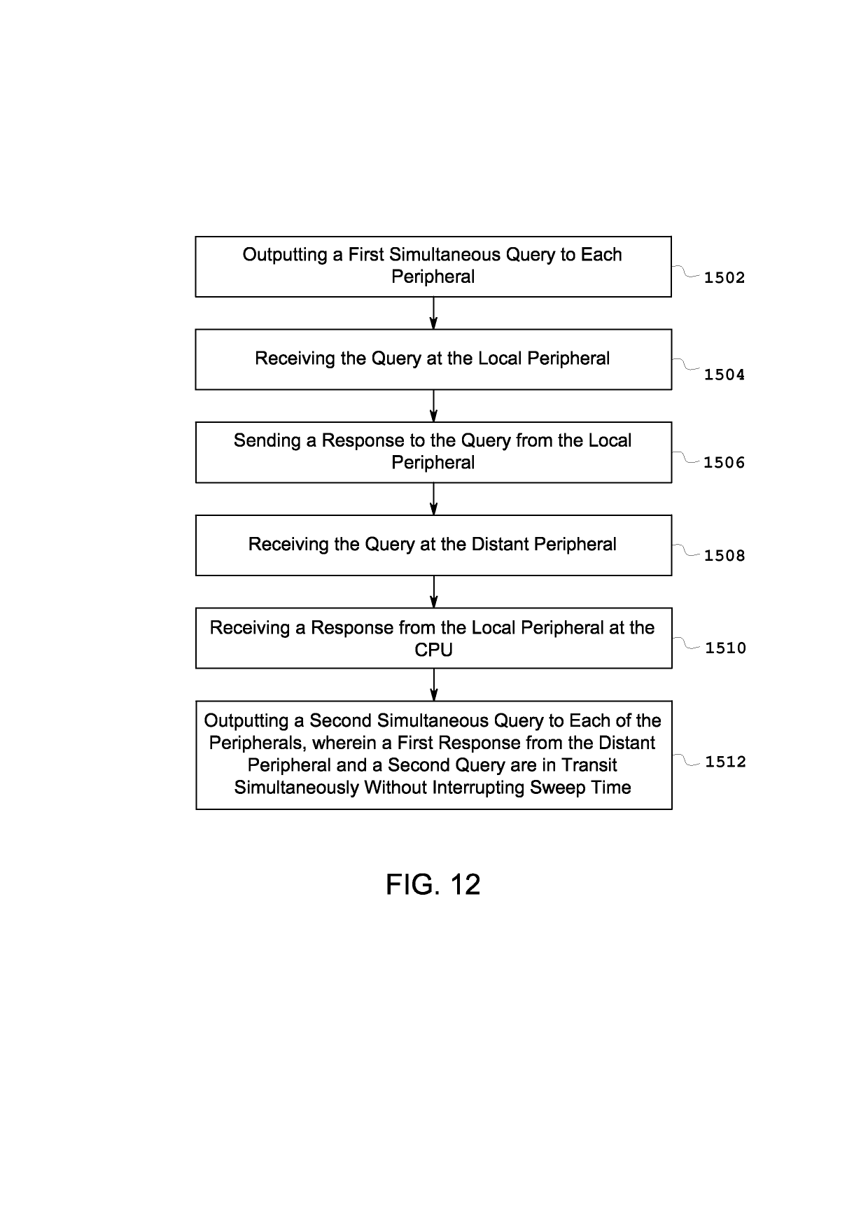

This system is applicable to an embodiment of the present invention in which the CPU transactional polls the peripherals to maximize the bandwidth utilization by allowing multiple peripheral queries to be in transit at the same time. This method can also be used to allow multiple queries to a single distant peripheral such that the transactions span multiple scan periods with the potential for multiple transactions to be in transit at any one time. Many industrial systems have both local and distant peripherals. In some situations, the CPU cycle time may be less than the time it takes for data packets to complete a circuit, leading to latency problems and increased scan times. The method according to FIG. 12, and used in relation to the system of FIGS. 1-11, addressed this problem.

With reference to FIGS. 11a-11l there is shown a functional block diagram representing eleven successive frames of time (t1-t11), while FIG. 12 illustrates a flow chart, which when viewed together, help illustrate the method for polling peripherals. While the flowchart shows an exemplary step-by-step method, it is to be appreciated that a skilled artisan may rearrange or reorder the steps while maintaining like results.

At step 502, FIG. 11a, (t1), 0 m/s, the controller CPU 1100 outputs a query for data to all three peripherals 1120, 1130 and 1140 through a single fiber or copper cable 1160. In this exemplary embodiment, the sweep is set at 10 millisecond (m/s) intervals.

At step 504, FIG. 11b, (t2), 1 m/s, the data packets are split from a single serial stream to three parallel streams, each of the streams destined for one of three peripheral. At this time, the query has reached the local peripheral 1110 and the local remote peripheral 1120 but is still in transit to the distant remote peripheral.

At step 506, FIG. 11c, (t3), 2 m/s, the local peripheral 1110 and close remote peripheral 1120 have responded (P1R1 and P2R1) and have output data packets to the controller.

At step 508, FIG. 11d, (t4), 3 m/s, the responses P1R1 and P2R2 have been transferred to serial communication and sent to the CPU for storage, execution, and the like.

At step 510, FIG. 11e, (t5), 10 m/s, the controller CPU 1100 outputs a second query P1Q2, P3Q2 and P3Q2 to all three peripherals 1120, 1130 and 1140 through a single fiber or copper cable 1160. P2R1 from the distant remote peripheral is capable of returning to the PCU simultaneously, due in part to the PCIe switch 1110.

At step 512, FIG. 11(f), (t6), 11 m/s, each of the second queries P1Q2 and P2Q2 have reached the local peripheral 1120 and close remote peripheral 1130, while P3R1, the first response from the distant peripheral has reached the controller CPU while P3Q2 is in route to the distant remote peripheral 1140.

These steps can continue over a predetermined period of time. In an exemplary embodiment, each of the fiber optical cable speeds run at 200e-6 m/s, and the most distant a peripheral can be have zero scan latency under this scenario is up to 100 miles (approximately 160 kilometers). Utilizing unique transaction numbers, the number of scans of latency can be determined and reported back to the user-logic as an attribute associated with the variable representing the point being measured. In this way, the user logic could compensate as necessary for the latency. PCIe may also be utilized to allow smart remote peripherals to periodically poll its inputs and send unsolicited data back to the central CPU. In this embodiment, The CPU sends periodic synchronization commands to all peripherals based on clock drift calculated from the accuracy of the CPU and peripheral clock generators.

Specific configurations and arrangements of the claimed invention, discussed below with reference to the accompanying drawings, are for illustrative purposes only. Other configurations and arrangements that are within the purview of a skilled artisan can be made, used, or sold without departing from the spirit and scope of the appended claims. For example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

As used herein, an element or function recited in the singular and proceeded with the word “a” or “an” should be understood as not excluding plural said elements or functions, unless such exclusion is explicitly recited. Furthermore, references to “one embodiment” of the claimed invention should not be interpreted as excluding the existence of additional embodiments that also incorporate the recited features.

The construction and arrangement of the elements described herein are illustrative only. Although only a few embodiments have been described in detail in this disclosure, those of ordinary skill who review this disclosure will readily appreciate that many modifications are possible without materially departing from the novel teachings and advantages of the subject matter recited in the claims.

Accordingly, all such modifications are intended to be included within the scope of the methods and systems described herein.

The order or sequence of any process or method steps may be varied or re-sequenced according to alternative embodiments. Other substitutions, modifications, changes and omissions may be made in the design, operating conditions and arrangement of the embodiments without departing from the spirit and scope of the methods and systems described herein.

What is claimed is:

1. A system for transmitting and receiving data using an industrial expansion bus connected to a chassis, the industrial expansion bus having a plurality of module slots, the system comprising:
a programmable logic controller (PLC) control rack comprising:
a first embedded central processing unit (CPU);
a first peripheral component interconnect express (PCIe) module adapted to send and receive PCIe compliant signals; and
a PLC remote rack comprising:
a second PCIe module adapted to send and receive PCIe compliant signals; and
a second embedded CPU;
wherein the first PCIe module and the second PCIe module are communicatively coupled with a cable to provide an interface between the first and second CPUs.

2. The system of claim 1, further comprising a first PHY layer adapter connected to the PCIe module, the PCIe module and adapted to communicate with the industrial expansion bus.

3. The system of claim 1, further comprising a second PHY layer adapter connected to the second PCIe module and adapted to communicate with the industrial expansion bus.

4. The system of claim 1, wherein the first and second PCUs are connected though each of the first and second PHYs.

5. The system of claim 1, further comprising a first PCI to PCIe bridge coupled to the PCIe module and adapted to convert a plurality of parallel data streams to a serial data stream.

6. The system of claim 1, further comprising a PCIe switch coupled to the embedded processor of the PCL control rack, a configured to create multiple endpoints for the connection of a plurality of peripherals, wherein each of the plurality of peripherals comprise PLC remote racks, motors, cylinders, relays, solenoids, switches, sensors or valves.

7. The system of claim 6, wherein the plurality of peripherals comprise a local peripheral, a close remote peripheral, and a distant remote peripheral, a relative distance being defined by a processor sweep time, wherein the embedded processor is configured to output multiple queries to each of the peripherals.

8. The system of claim 7, wherein the plurality of peripherals are each configured to output a response signal, and wherein the response signals and queries are adapted to be in transit simultaneously.

9. The system of claim 1, wherein the remote PLC rack further comprises:
a PCIe interface coupled to the second SFP module;
a PCI interface coupled to the SFP module;
a dual port RAM interposed between the PCIe interface and the PCI interface;
wherein the remote second CPU is configured to read or write predetermined parameters to the dual port RAM in the second PCIe to provide control of the distant remote peripheral.

10. The system of claim 1, further comprising a PCIe switch coupled to the PCIe module and, the PCIe switch configured to create multiple endpoints from a single endpoint, each endpoint connected to the plurality of peripherals.

11. The system of claim 1, wherein the PCIe industrial expansion bus is utilized as a local backplane bus and configured to connect a PCI module to a PCIe module residing on the backplane.

12. The system of claim 1, wherein the plurality of peripherals and the PLC control module are configured in a daisy-chain, a ring topology, or a linear topology.

13. The system of claim 1, wherein the PCL control rack is connectable to both a PCI/PCIe expansion chassis or a PC workstation.

14. The system of claim 1, further comprising a second CPU control rack communicatively coupled to the first control rack and configure to provide redundant controls and to provide shared memory.

15. A system for transmitting and receiving data using an industrial expansion bus connected to a chassis, the industrial expansion bus having a plurality of module slots, the system comprising:
a programmable logic controller (PLC) control rack having a central processing unit and a first peripheral component interconnect express (PCIe) module adapted to send and receive PCIe compliant signals; and
a PLC remote rack having a second PCIe module coupled to the first PCIe module and adapted to send and receive PCIe compliant signals to and from the first PCIe module;
wherein the PLC remote rack is configured to execute commands received from the CPU of the PLC control rack.

16. The system of claim 15, further comprising a first PCI to PCIe bridge coupled to the PCIe module and adapted to convert a plurality of parallel data streams to a serial data stream.

17. The system of claim 15, further comprising a second PCI to PCIe bridge coupled to the PCL remote rack PCIe module and adapted convert the serial data stream to a plurality of parallel data streams.

18. The system of claim 15, further comprising a first PHY layer adapter connected to the PCIe module, the PCIe module and adapted to communicate with the industrial expansion bus.

19. The system of claim 15, further comprising a second PHY layer adapter connected to the second PCIe module and adapted to communicate with the industrial expansion bus;
wherein the first PCIe module and the second PCIe module are communicatively coupled with a fiber or copper cable connected though each of the first and second PHYs and configured to provide an interface between the first and second CPUs.

20. A method for polling a local peripheral and a distant peripheral, distance being defined as a function of sweep time, the method executable by a central processing unit, and comprising:
outputting a first simultaneous query to each of the peripherals;
receiving the query at the local peripheral;
sending a response to the query from the local peripheral;
receiving the query at the distant peripheral;
receiving a response from the local peripheral at the CPU; and
outputting a second simultaneous query to each of the peripherals, wherein a first response from the distant peripheral and a second query are in transit simultaneously without interrupting the sweep time.

21. The method of claim 20, wherein of the outputting, receiving, and sending steps occur continuously over a predetermined period of time over a fiber optic cable.

22. The method of claim 20, wherein the sweep time is set at ten milliseconds intervals.

23. The method of claim 20, wherein outputting a simultaneous query comprises splitting a data packet from a single serial stream to two parallel streams, each of the streams destined for the local or the distant peripheral.

24. The method of claim 20, wherein each query comprises a unique transaction identifier, and a number of scans of latency is determined and reported back to the CPU.
